(19) United States
(12) Patent Application Publication
(10) Pub. No.: US 2017/0310700 A1
(43) Pub. Date: Oct. 26, 2017

(54) SYSTEM FAILURE EVENT-BASED APPROACH TO ADDRESSING SECURITY BREACHES

(71) Applicant: Lenovo Enterprise Solutions (Singapore) Pte. Ltd., Singapore (SG)

(72) Inventors: Gary David Cudak, Wake Forest, NC (US); Ajay Dholakia, Cary, NC (US); Scott Kelso, Cary, NC (US); Fred Allison Bower, III, Durham, NC (US)

(21) Appl. No.: 15/134,322

(22) Filed: Apr. 20, 2016

(51) Int. Cl. H04L 29/06; G06F 11/14

(52) U.S. Cl. CPC H04L 63/1441; H04L 63/14; G06F 11/1469; G06F 11/1471; G06F 2201/84

(57) ABSTRACT

A method includes: detecting a potential security breach associated with at least one component of a network environment; in response to detecting the potential security breach, determining a restorable state of the at least one component, wherein the restorable state is a state prior to the potential security breach; restoring the at least one component to the restorable state; and resuming operation of the at least one component of the network. Corresponding systems and computer program products are also disclosed.

### FIELD OF THE INVENTION

The present invention relates to handling security breaches of computer systems in a network environment, and more particularly, this invention relates to improving the function of network environments such as data processing clusters by addressing security breaches as system failure events.

### BACKGROUND

Conventionally, a security breach in a network environment such as a compute cluster coupled to one or more other components servers, workstations, switches, and storage devices) results in the breached system(s) being quarantined. The quarantine process advantageously ensures damage associated with the breach does not propagate to other systems in the network environment.

However, this quarantine process incurs performance detriments to the network environment. For instance, isolating the breached component in a quarantine removes the component's corresponding functional contribution to the network environment, e.g. reduced processing power, memory availability, network bandwidth, storage capacity, etc., for the duration of the quarantine. Since existing techniques for detecting the particular type of breach, identifying the source and/or impact of the breach, and resolving the breach are both computationally- and time-intensive processes, the quarantine procedure can result in significant detriments to overall system performance.

In addition, processes being handled by or otherwise relying on the breached component may be compromised or lost entirely due to the breach, particularly when other, e.g. non-breached components, are dependent upon the completion of processes handled by the breached component. These losses further detriment the performance of the system as a whole.

Accordingly, it would be beneficial to provide systems, methods, computer program products and the like which avoid the problems associated with quarantine-based approaches to addressing security breaches in a network environment.

### SUMMARY

In one embodiment, a computer program product includes a computer readable medium having stored thereon computer readable program instructions. The program instructions are configured to cause a processor of a computer system to: detect a potential security breach associated with at least one component of a network environment; in response to detecting the potential security breach, determine a restorable state of the at least one component, wherein the restorable state is a state prior to the potential security breach; restore the at least one component to the restorable state; and resume operation of the at least one component of the network.

In another embodiment, a method includes: detecting a potential security breach associated with at least one component of a network environment in response to detecting the potential security breach, determining a restorable state of the at least one component, wherein the restorable state is a state prior to the potential security breach; restoring the at least one component to the restorable state; and resuming operation of the at least one component of the network.

In yet another embodiment, a system includes a processor configured to: detect a potential security breach associated with at least one component of a network environment; in response to detecting the potential security breach, determine a restorable state of the at least one component, wherein the restorable state is a state prior to the potential security breach; restore the at least one component to the restorable state; and resume operation of the at least one component of the network.

Other aspects and advantages of the present invention will become apparent from the following detailed description, which, when taken in conjunction with the drawings, illustrate by way of example the principles of the invention.

### BRIEF DESCRIPTION OF THE DRAWINGS

FIG. 1 is a schematic drawing of a computer network environment, according to one approach.

FIG. 2 depicts a simplified schematic of a computing workstation, according to one embodiment.

FIG. 3 depicts an exemplary network environment, according to one embodiment.

FIG. 4 shows a flowchart of a method, according to one approach.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

In one general embodiment, a computer program product includes a computer readable medium having stored thereon computer readable program instructions. The program instructions are configured to cause a processor of a computer system to: detect a potential security breach associated with at least one component of a network environment; in response to detecting the potential security breach, determine a restorable state of the at least one component, wherein the restorable state is a state prior to the potential security breach; restore the at least one component to the restorable state; and resume operation of the at least one component of the network.

In another general embodiment, a method includes: detecting a potential security breach associated with at least one component of a network environment; in response to detecting the potential security breach, determining a restorable state of the at least one component, wherein the restorable state is a state prior to the potential security breach; restoring the at least one component to the restorable state; and resuming operation of the at least one component of the network.

In yet another general embodiment, a system includes a processor configured to: detect a potential security breach associated with at least one component of a network environment; in response to detecting the potential security breach, determine a restorable state of the at least one component, wherein the restorable state is a state prior to the potential security breach; restore the at least one component to the restorable state; and resume operation of the at least one component of the network.

General Computing Concepts

The description herein is presented to enable any person skilled in the art to make and use the invention and is provided in the context of particular applications of the invention and their requirements. Various modifications to the disclosed embodiments will be readily apparent to those skilled in the art and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

In particular, various embodiments of the invention discussed herein are implemented using the Internet as a means of communicating among a plurality of computer systems. One skilled in the art will recognize that the present invention is not limited to the use of the Internet as a communication medium and that alternative methods of the invention may accommodate the use of a private intranet, a Local Area Network (LAN), a Wide Area Network (WAN) or other means of communication. In addition, various combinations of wired, wireless (e.g., radio frequency) and optical communication links may be utilized.

The program environment in one embodiment of the invention may be executed illustratively incorporates one or more general-purpose computers or special-purpose devices such hand-held computers. Details of such devices (e.g., processor, memory, and data storage, input and output devices) are well known and are omitted for the sake of clarity.

It should also be understood that the techniques of the present invention might be implemented using a variety of technologies. For example, the methods described herein may be implemented in software running on a computer system, or implemented in hardware utilizing one or more processors and logic (hardware and/or software) for performing operations of the method, application specific integrated circuits, programmable logic devices such as Field Programmable Gate Arrays (FPGAs), and/or various combinations thereof. In one illustrative approach, methods described herein may be implemented by a series of computer-executable instructions residing on a storage medium such as a physical (e.g., non-transitory) computer-readable medium. In addition, although specific embodiments of the invention may employ object-oriented software programming concepts, the invention is not so limited and is easily adapted to employ other forms of directing the operation of a computer.

The invention can also be provided in the form of a computer program product comprising a computer readable storage or signal medium having computer code thereon, which may be executed by a computing device (e.g., a processor) and/or system. A computer readable storage medium can include any medium capable of storing computer code thereon for use by a computing device or system, including optical media such as read only and writeable CD and DVD, magnetic memory or medium (e.g., hard disk drive, tape), semiconductor memory (e.g., FLASH memory and other portable memory cards, etc.), firmware encoded in a chip, etc.

A computer readable signal medium is one that does not fit within the aforementioned storage medium class. For example, illustrative computer readable signal media communicate or otherwise transfer transitory signals within a system, between systems e.g., via a physical or virtual network, etc.

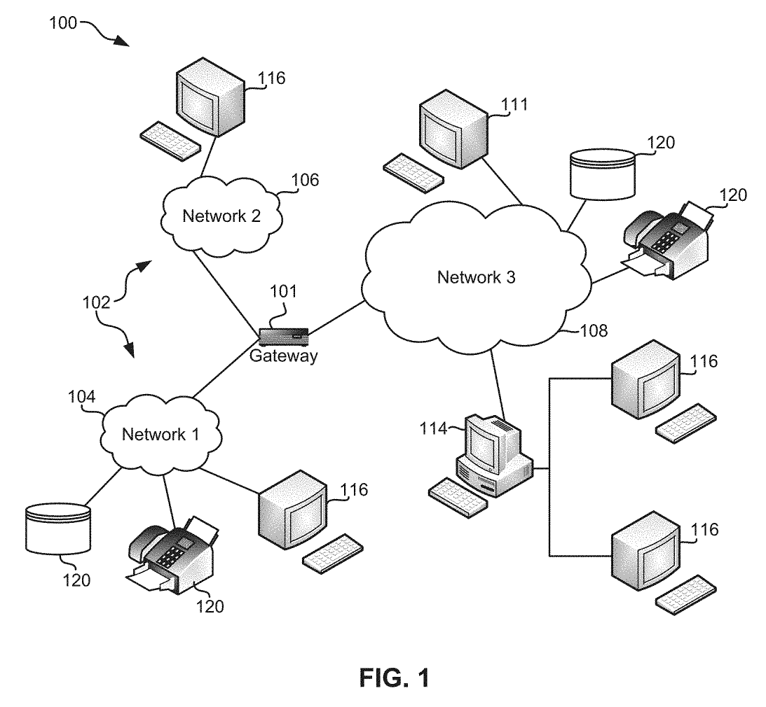

FIG. 1 illustrates an architecture 100, in accordance with one embodiment. As an option, the present architecture 100 may be implemented in conjunction with features from any other embodiment listed herein, such as those described with reference to the other FIGS. Of course, however, such architecture 100 and others presented herein may be used in various applications and/or in permutations which may or may not be specifically described in the illustrative embodiments listed herein. Further, the architecture 100 presented herein may be used in any desired environment.

As shown in FIG. 1, a plurality of remote networks 102 are provided including a first remote network 104 and a second remote network 106. A gateway 101 may be coupled between the remote networks 102 and a proximate network 108. In the context of the present network architecture 100, the networks 104, 106 may each take any form including, but not limited to a LAN, a WAN such as the Internet, public switched telephone network (PSTN), internal telephone network, etc.

In use, the gateway 101 serves as an entrance point from the remote networks 102 to the proximate network 108. As such, the gateway 101 may function as a router, which is capable of directing a given packet of data that arrives at the gateway 101, and a switch, which furnishes the actual path in and out of the gateway 101 for a given packet.

Further included is at least one data server 114 coupled to the proximate network 108, and which is accessible from the remote networks 102 via the gateway 101. It should be noted that the data server(s) 114 may include any type of computing device/groupware. Coupled to each data server 114 is a plurality of user devices 116. Such user devices 116 may include a desktop computer, laptop computer, hand-held computer, printer or any other type of logic. It should be noted that a user device 111 may also be directly coupled to any of the networks, in one embodiment.

A peripheral 120 or series of peripherals 120, e.g. facsimile machines, printers, networked storage units, etc., may be coupled to one or more of the networks 104, 106, 108. It should be noted that databases, servers, and/or additional components may be utilized with, or integrated into, any type of network element coupled to the networks 104, 106, 108. In the context of the present description, a network element may refer to any component of a network.

According to some approaches, methods and systems described herein may be implemented with and/or on virtual systems and/or systems which emulate one or more other systems, such as a UNIX system which emulates a MAC OS environment, a UNIX system which virtually hosts a MICROSOFT WINDOWS environment, a MICROSOFT WINDOWS system which emulates a MAC OS environment, etc. This virtualization and/or emulation may be enhanced through the use of VMWARE software, in some embodiments.

In more approaches, one or more networks 104, 106, 108, may represent a cluster of systems commonly referred to as a “cloud.” In cloud computing, shared resources, such as processing power, peripherals, software, data processing and/or storage, servers, etc., are provided to any system in the cloud, preferably in an on-demand relationship, thereby allowing access and distribution of services across many computing systems. Cloud computing typically involves an Internet or other high speed connection (e.g., 4G LTE, fiber optic, etc.) between the systems operating in the cloud, but other techniques of connecting the systems may also be used.

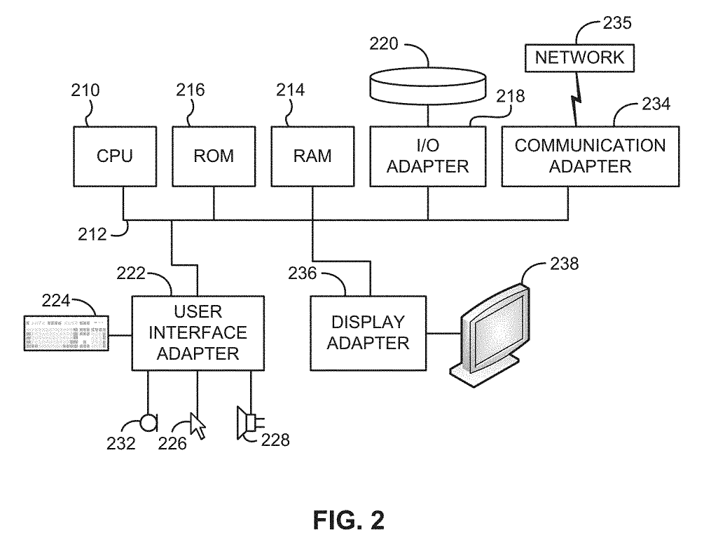

FIG. 2 shows a representative hardware environment associated with a user device 116 and/or server 114 of FIG. 1, in accordance with one embodiment. Such figure illustrates a typical hardware configuration of a workstation having a central processing unit 210, such as a microprocessor, and a number of other units interconnected via a system bus 212.

The workstation shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen and a digital camera (not shown) to the bus 212, communication adapter 234 for connecting the workstation to a communication network 235 (e.g., a data processing network) and a display adapter 236 for connecting the bus 212 to a display device 238.

The workstation may have resident thereon an operating system such as the Microsoft WINDOWS Operating System (OS), a MAC OS, a UNIX OS, etc. It will be appreciated that a preferred embodiment may also be implemented on platforms and operating systems other than those mentioned. A preferred embodiment may be written using JAVA, XML, C, and/or C++ language, or other programming languages, along with an object oriented programming methodology. Object oriented programming (OOP), which has become increasingly used to develop complex applications, may be used.

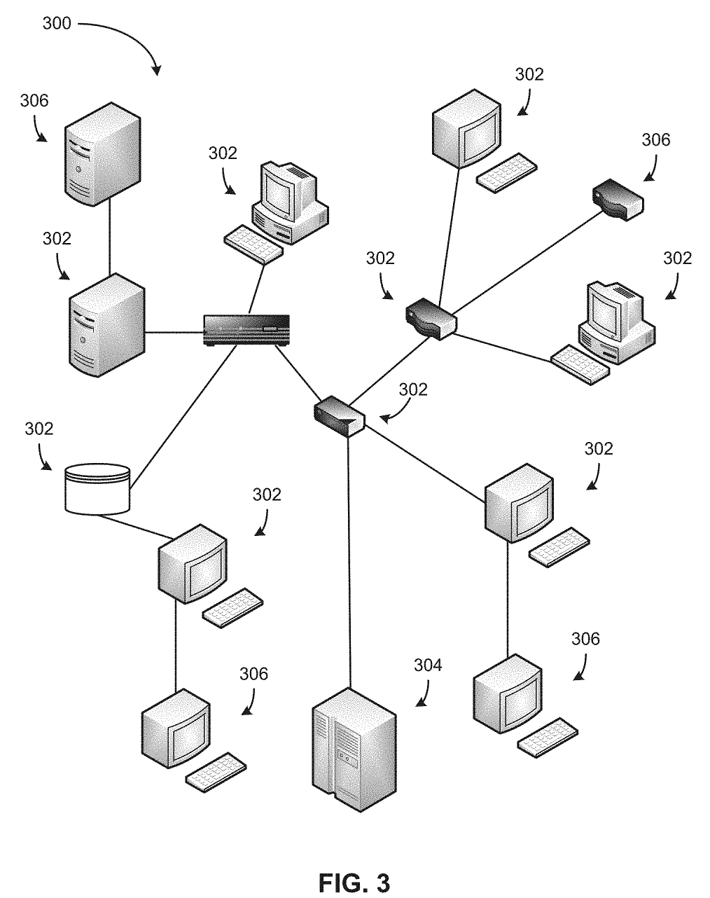

In one embodiment, and as shown in FIG. 3, the presently disclosed inventive concepts may be implemented in a network environment 300 such as a compute cluster, a storage area network (SAN), a LAN, a WAN, or any other suitable environment including a plurality of components 302 (preferably hardware components but optionally including one or more virtualized components in various embodiments) communicatively coupled to a server 304 such as a management server.

In one approach, the architecture 100 shown in FIG. 1 may be considered an illustrative embodiment of a network environment 300, and/or the representative hardware environment shown in FIG. 2 may be considered an exemplary embodiment of a hardware component 302 and/or server 304.

The network environment 300 includes a plurality of components 302, which may include one or more of servers, routers, switches, data storage devices, compute nodes (preferably including a memory and a processor or processors), workstations, bridges, etc. as would be understood by a person having ordinary skill in the art upon reading the present descriptions.

In general, and according to preferred embodiments, the server 304 is a management server configured to survey the components 302 of the network environment 300, determine configuration information for the various components 302, and build profile(s) for different component types. In various embodiments, component types may include compute components (e.g. data processing nodes or clusters, workstations, etc.), management components (e.g. filesystem servers, web servers, etc.), networking components (e.g. switches, routers, bridges, ports, etc.), storage components (e.g. HDD-based storage, SSD-based storage, tape-based storage, memory-based storage, etc.), or any other suitable type of component for inclusion in various different types of network architectures. In more approaches, component types may be defined or determined based on a unique context of the network environment 300.

Components of the network environment may advantageously be characterized by having associated therewith one or more redundant “shadow” components 306, which enables the inventive and advantageous maintenance of network environment performance in event of a potential security breach while simultaneously isolating the affected component(s) 302 to avoid propagating the breach or detrimental impact thereof.

As understood herein, a shadow component is a component essentially identical or functionally equivalent to a corresponding component of the network environment, but which is not directly accessible or visible to the network environment for purposes of performing workloads. In this manner, the shadow components are isolated from potential security breaches because the origin of the potential breach is not capable of enacting a breach on the shadow component, in preferred approaches.

Skilled artisans will appreciate, upon reading these disclosures, that it is desirable in some embodiments to maintain a degree of independence between shadow components and corresponding components of the network environment (e.g. a predetermined distance between IP addresses assigned to the component(s) and corresponding shadow component(s)) so as to minimize the likelihood of a breach targeting a component to “spill-over” to the associated shadow component due to proximity between the two. In certain embodiments, the amount of distance necessary or sufficient to accomplish adequate independence may be defined by a user, e.g. an administrator or owner of the network environment, based in whole or in part on an amount of risk the network environment may tolerate.

Preferably, to facilitate accurate identification of actual security breaches and minimize false positive reports, the one or more components and corresponding shadow components are characterized by identical capabilities with respect to performing workloads. For instance, the component(s) and corresponding shadow component(s) may have allocated thereto an identical amount of processing resources, e.g. processor speed, memory allocation, data storage, etc.; an identical network configuration, e.g. access to the same or a functionally equivalent set of networked components and/or network resources, etc. as would be understood by a person having ordinary skill in the art upon reading the present disclosures.

In more embodiments, the one or more component(s) and corresponding shadow component(s) may include functionally equivalent or identical virtual machines, virtual switches, etc.

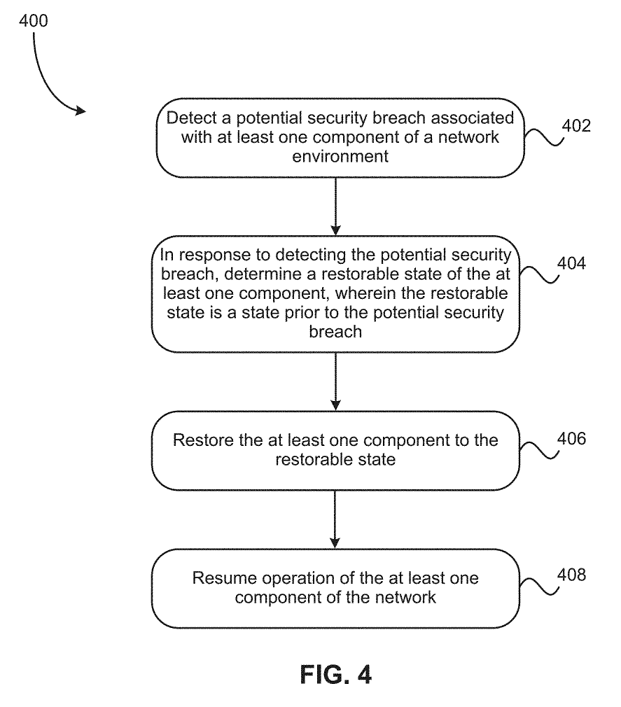

Now referring to FIG. 4, a flowchart of a method 400 is shown according to one embodiment. The method 400 may be performed in accordance with the present invention in any of the environments depicted in FIGS. 1-3, among others, in various embodiments. Of course, more or less operations than those specifically described in FIG. 4 may be included in method 400, as would be understood by one of skill in the art upon reading the present descriptions.

Each of the steps of the method 400 may be performed by any suitable component of the operating environment. For example, in various embodiments, the method 400 may be partially or entirely performed by a management server of a network environment, or some other device having one or more processors therein such as a cluster. The processor, e.g., processing circuit(s), chip(s), and/or module(s) implemented in hardware and/or software, and preferably having at least one hardware component may be utilized in any device to perform one or more steps of the method 400. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 4, method 400 may initiate with operation 402, where a potential security breach is detected. The potential security breach is detected in association with one or more component(s) of a network environment such as shown in FIGS. 1-3.

In various approaches, detecting potential security breaches may be accomplished by tracking performance of one or more components of the network environment. Advantageously, tracking performance over time allows precise determination of the point in time at which a potential security breach was initiated, and thus restore components to a state corresponding to the closest point in time prior to initiation of the potential security breach. Accordingly the restoration process may minimize the amount of changes necessary to resolve the security breach, and may do so on a per-component basis.

Additionally and/or alternatively, tracking may include monitoring the configuration of various components of the network environment, and determining a configuration state associated with a potential security breach. Restoration may correspondingly involve restoring a component's configuration to a point in time prior to the identified likely security breach initiation, in several embodiments.

As will be understood by a person having ordinary skill in the art upon reading the instant disclosures, potential security breach detection may be based on detecting anomalies, e.g. deviations from performance patterns, configuration states. etc. as mentioned above. The identification of an anomaly may be an internal determination, based on comparing component performance/configuration to prior, stable performance/configuration information, in one approach.

In another approach, potential security breaches may be detected based in whole or in part on information determined from an external monitoring component. For example, a network monitor may observe network traffic and detect an attack or an exploit either emanating from or targeted at a particular system or subsystem. Preferably, the monitor is external in that the monitor engages in passive observation of components of the network environment, rather than a component tracking its own performance or configuration over time to determine deviations. This passive observation makes the monitor a less likely target for security breaches than the active components of the network environment, facilitating security breach detection, in some approaches.

In even more approaches, the external monitor may include a trusted entity or component which has awareness of identity of various components of the network environment which do not have direct awareness of each other's identity. In this embodiment, the external monitor acts as a trusted broker to ensure appropriate passage of information between components, restoration of components to a particular state, etc. For instance, in one approach upon detecting a potential security breach, in order to restore the affected component(s) to a known good working state, the external monitor may broker the transmission of configuration settings, firmware, etc. between a source and the affected component to ensure the restoration will be successful and will not propagate the breach to other components of the system, and/or propagate a second breach to the affected components).

In response to detecting the potential security breach, method 400 includes operation 404, in which a restorable state of the component(s) is determined. The restorable state is a state prior to the potential security breach, and may include a restore point created by the component, or simply a state of the component, e.g. as reflected in a system log, checkpointing process, etc. as would be understood by a person having ordinary skill in the art upon reading the present disclosures.

Method 400 accordingly further includes restoring the component(s) to the restorable state, in operation 406. Preferably, it is the act of restoring the component(s) to the restorable state which resolves the potential security breach.

In operation 408, the restored component(s) operation within the network environment is resumed, preferably with the potential security breach having been resolved.

Accordingly, in the interim between detecting the potential security breach and resolving the potential security breach, operation of the affected component(s) may be isolated or removed from the network environment to avoid propagating the potential security breach and/or detrimental impact thereof across the network environment. However, as will be discussed below, overall performance of the network environment may be maintained by implementing system failure event-based techniques such as failover to a redundant component or component(s).

Of course, as noted above, method 400 may include one or more additional and/or alternative operations, features, functions, etc. For instance, in various approaches, method 400 may include any combination of the following.

In one instance, the method 400 may include determining the restorable state via one or more of evaluating one or more micro-checkpoints corresponding to the at least one component; and verifying an operating status of the at least one component for the one or more micro-checkpoints.

In various embodiments, verifying operating status of the component(s) may be accomplished using any suitable technique, tool, etc. that would be appreciated by a person having ordinary skill in the art upon reading the present descriptions. Preferably, the verification process, if associated with overhead comparable to conventional malware or other breach detection techniques, may be performed at a later time, e.g. during non-peak hours, in order to minimize the impact on the network environment as a whole. Even more preferably, where verification is delayed, a failover approach is used to minimize performance impact of the potential breach on the network environment.

In additional approaches, detecting the potential security breach may be based at least in part on: monitoring one or more shadow components associated with the at least one component of the network environment, wherein the one or more shadow components synchronously perform a mirrored version of one or more workloads being handled by the at least one component; determining whether the one or more shadow components and the at least one component have deviated from synchronous performance of the mirrored version of the one or more workloads and the one or more workloads, respectively; and in response to determining the one or more shadow components and the at least one component have deviated from synchronous performance of the mirrored version of the one or more workloads and the one or more workloads, reporting the potential security breach.

In determining whether component(s) and corresponding shadow components have deviated from synchronous performance, in preferred approaches extraneous sources of potential deviation are taken into account, e.g. network latency, differences in time of initiating workload execution, differences in type of code being executed, differences in clocking mechanisms between components, etc. as would be understood by a person having ordinary skill in the art upon reading the instant descriptions. Thus, isolating the synchronicity evaluation to deviations that arise solely due to differential performance of the component(s) and corresponding shadow component(s) facilitates identification of true security breaches as opposed to deviations resulting from other sources of performance impact.

Moreover, determining whether the one or more shadow components and the at least one component have deviated from synchronous performance of the mirrored version of the one or more workloads and the one or more workloads may be based at least in part on comparing one or more performance metrics of the one or more shadow components and the at least one component.

The one or more performance metrics are preferably selected from a group consisting of: execution time associated with performing the mirrored version of the one or more workloads and the one or more workloads, progress of the mirrored version of the one or more workloads relative to progress of the one or more workloads; memory usage associated with performing the mirrored version of the one or more workloads and the one or more workloads, network behavior associated with performing the mirrored version of the one or more workloads and the one or more workloads.

For example, if a component performing a workload or workloads and a shadow component performing a corresponding, mirrored version of the workload(s) exhibit a deviation in execution time, memory usage, or network behavior, this may be indicative of a potential security breach because the security breach may be consuming additional processing resources, causing differential memory utilization, and/or causing differential network behavior (e.g. the potentially breached component(s) accessing different and/or more resources of the network environment than the shadow component(s)). In one embodiment, where execution time and/or workload progress are employed as the metric, a deviation on the order of milliseconds may be considered indicative of a potential security breach.

Restoring the components operation within the network may additionally and/or alternatively include resetting accessible infrastructure within the network environment.

In various embodiments, resetting accessible infrastructure may include resetting switch configuration files to a default configuration, and/or a configuration corresponding to a point in time prior to the potential security breach. In more approaches, resetting accessible infrastructure may include resetting firmware associated with one or more components of the network environment, preferably including the at least one component for which the potential security breach was detected. In still more embodiments, resetting accessible infrastructure may include resetting virtual machine configuration settings to a default configuration, and/or a configuration corresponding to a point in time prior to the potential security breach.

As mentioned above, maintaining network environment functionality and performance may advantageously include implementing a failover of workloads handled by the at least one component to one or more corresponding shadow components of the network environment.

Failover, in various approaches, may include making the shadow component accessible to other components of the network environment, such that the shadow component effectively replaces the potentially breached component to allow workload processing to continue with minimal interruption. Failover may thus include configuring the shadow component, e.g. in terms of network connectivity, network identity/location (for instance component II), domain name lookup, IP address, etc), or any other suitable configuration of parameters that would be understood by a person having ordinary skill in the art upon reading the present disclosure.

Similarly, to restore redundancy, upon resolving the potential breach the component(s) for which workloads were failed-over to the corresponding shadow systems may be reinstated, and/or serve as shadow components to the component handling the failed-over workload, in several embodiments.

Failover is a particularly attractive solution to security breaches such as distributed denial of service (DUOS) attacks which continuously impact the performance of a particular component or components of a network environment.

As will be understood by those having ordinary skill in the art upon reading the instant descriptions, any feature or functionality disclosed herein may be optionally implemented in a computer program product. According to these embodiments, a computer program product may include a computer readable medium having stored thereon computer readable program instructions configured to cause a processor of a computer system to: determine a configuration of one or more networked hardware components; determine a usage level associated with one or more of the networked hardware components; and determine a functional category of one or more of the networked hardware components based at least in part on the configuration of the one or more networked hardware components and the usage level associated with the one or more networked hardware components.

Of course the computer program product may additionally and/or alternatively include any combination of functions or features as described herein, in more approaches.

By implementing the aforementioned techniques, features, and components, in various embodiments, the presently disclosed inventive concepts advantageously improve the function of network environments and associated systems by resolving security breaches without incurring the overhead and potential loss associated with implementing a quarantine and resolving the security breach using conventional techniques. By leveraging much faster and computationally efficient roll-back techniques, the security breach may be resolved without utilizing time and resources associated with searching an entire system for the origin and/or cause of the breach and subsequently resolving the breach.

The inventive concepts disclosed herein have been presented by way of example to illustrate the myriad features thereof in a plurality of illustrative scenarios, embodiments, and/or implementations. It should be appreciated that the concepts generally disclosed are to be considered as modular, and may be implemented in any combination permutation, or synthesis thereof. In addition, any modification, alteration, or equivalent of the presently disclosed features, functions, and concepts that would be appreciated by a person having ordinary skill in the art upon reading the instant descriptions should also be considered within the scope of this disclosure.

While various embodiments have been described above, it should be understood that they have been presented by way of example only, and not limitation. Thus, the breadth and scope of an embodiment of the present invention should not be limited by any of the above-described exemplary embodiments, but should be defined only in accordance with the following claims and their equivalents.

What is claimed is:

1. A computer program product, comprising: a computer readable medium having stored thereon computer readable program instructions configured to cause a processor of a computer system to:
detect a potential security breach associated with at least one component of a network environment;
in response to detecting the potential security breach, determine a restorable state of the at least one component, wherein the restorable state is a state prior to the potential security breach;
restore the at least one component to the restorable state; and
resume operation of the at least one component of the network.

2. The computer program product as recited in claim 1, wherein determining the restorable state comprises one or more of evaluating one or more micro-checkpoints corresponding to the at least one component; and verifying an operating status of the at least one component for the one or more micro-checkpoints.

3. The computer program product as recited in claim 1, comprising computer readable program instructions configured to cause the processor of the computer system to detect the potential security breach based at least in part on:
monitoring one or more shadow components associated with the at least one component of the network environment, wherein the one or more shadow components synchronously perform a mirrored version of one or more workloads being handled by the at least one component;
determining whether the one or more shadow components and the at least one component have deviated from synchronous performance of the mirrored version of the one or more workloads and the one or more workloads, respectively; and
in response to determining the one or more shadow components and the at least one component have deviated from synchronous performance of the mirrored version of the one or more workloads and the one or more workloads, reporting the potential security breach.

4. The computer program product as recited in claim 3, wherein determining whether the one or more shadow components and the at least one component have deviated from synchronous performance of the mirrored version of the one or more workloads and the one or more workloads is based at least in part on comparing one or more performance metrics of the one or more shadow components and the at least one component.

5. The computer program product as recited in claim 4, wherein the one or more performance metrics are selected from a group consisting of:
execution time associated with performing the mirrored version of the one or more workloads and the one or more workloads;
progress of the mirrored version of the one or more workloads relative to progress of the one or more workloads;
memory usage associated with performing the mirrored version of the one or more workloads and the one or more workloads; and
network behavior associated with performing the mirrored version of the one or more workloads and the one or more workloads.

6. The computer program product as recited in claim 1, comprising computer readable program instructions configured to cause the processor of the computer system to reset accessible infrastructure within the network environment.

7. The computer program product as recited in claim 1, comprising computer readable program instructions configured to failover the at least one component to one or more corresponding shadow components of the network environment.

8. The computer program product as recited in claim 1, wherein restoring the at least one component to the restorable state resolves the potential security breach.

9. A method, comprising:
detecting a potential security breach associated with at least one component of a network environment;
in response to detecting the potential security breach, determining a restorable state of the at least one component, wherein the restorable state is a state prior to the potential security breach;
restoring the at least one component to the restorable state; and
resuming operation of the at least one component of the network.

10. The method as recited in claim 9, wherein determining the restorable state comprises one or more of evaluating one or more micro-checkpoints corresponding to the at least one component; and verifying an operating status of the at least one component for the one or more micro-checkpoints.

11. The method as recited in claim 9, wherein detecting the potential security breach is based at least in part on:
monitoring one or more shadow components associated with the at least one component of the network environment, wherein the one or more shadow components synchronously perform a mirrored version of one or more workloads being handled by the at least one component;
determining whether the one or more shadow components and the at least one component have deviated from synchronous performance of the mirrored version of the one or more workloads and the one or more workloads, respectively; and
in response to determining the one or more shadow components and the at least one component have deviated from synchronous performance of the mirrored version of the one or more workloads and the one or more workloads, reporting the potential security breach.

12. The method as recited in claim 11, wherein determining whether the one or more shadow components and the at least one component have deviated from synchronous performance of the mirrored version of the one or more workloads and the one or more workloads is based at least in part on comparing one or more performance metrics of the one or more shadow components and the at least one component.

13. The method as recited in claim 12, wherein the one or more performance metrics are selected from a group consisting of:
execution time associated with performing the mirrored version of the one or more workloads and the one or more workloads;
progress of the mirrored version of the one or more workloads relative to progress of the one or more workloads;
memory usage associated with performing the mirrored version of the one or more workloads and the one or more workloads; and
network behavior associated with performing the mirrored version of the one or more workloads and the one or more workloads.

14. The method as recited in claim 9, comprising resetting an accessible infrastructure within the network environment.

15. The method as recited in claim 9, comprising enforcing a failover of the at least one component to one or more corresponding shadow components of the network environment.

16. The method as recited in claim 9, wherein restoring the at least one component to the restorable state resolves the potential security breach.

17. A system, comprising a processor configured to:
detect a potential security breach associated with at least one component of a network environment;
in response to detecting the potential security breach, determine a restorable state of the at least one component, wherein the restorable state is a state prior to the potential security breach;
restore the at least one component to the restorable state; and
resume operation of the at least one component of the network.

18. The system as recited in claim 17, wherein determining the restorable state comprises one or more of evaluating one or more micro-checkpoints corresponding to the at least one component; and verifying an operating status of the at least one component for the one or more micro-checkpoints.

19. The system as recited in claim 17, wherein detecting the potential security breach is based at least in part on:
monitoring one or more shadow components associated with the at least one component of the network environment, wherein the one or more shadow components synchronously perform a mirrored version of one or more workloads being handled by the at least one component;
determining whether the one or more shadow components and the at least one component have deviated from synchronous performance of the mirrored version of the one or more workloads and the one or more workloads, respectively; and
in response to determining the one or more shadow components and the at least one component have deviated from synchronous performance of the mirrored version of the one or more workloads and the one or more workloads, reporting the potential security breach;
wherein determining whether the one or more shadow components and the at least one component have deviated from synchronous performance of the mirrored version of the one or more workloads and the one or more workloads is based at least in part on comparing one or more performance metrics of the one or more shadow components and the at least one component; and
wherein the one or more performance metrics are selected from a group consisting of:
execution time associated with performing the mirrored version of the one or more workloads and the one or more workloads;
progress of the mirrored version of the one or more workloads relative to progress of the one or more workloads;
memory usage associated with performing the mirrored version of the one or more workloads and the one or more workloads; and
network behavior associated with performing the mirrored version of the one or more workloads and the one or more workloads.

20. The system as recited in claim 17, wherein restoring the at least one component to the restorable state resolves the potential security breach.
